(19) United States
(12) Patent Application Publication
(10) Pub. No.: US 2012/0134020 A1
(43) Pub. Date: May 31, 2012

(54) IMAGE DISPLAY APPARATUS, IMAGE DISPLAY SYSTEM, AND IMAGE DISPLAY METHOD

(75) Inventors: Takashi TOYOOKA, Matsumoto-shi (JP); Kazuhisa MIZUSAKO, Matsumoto-shi (JP)

(73) Assignee: SEIKO EPSON CORPORATION, Tokyo (JP)

(21) Appl. No.: 13/298,143

(22) Filed: Nov. 16, 2011

(30) Foreign Application Priority Data
Nov. 26, 2010 (JP) 2010-264145

(51) Int. Cl. G02B 27/22

(52) U.S. Cl. 359/464

(57) ABSTRACT

An image display apparatus includes a light source controlled to be turned on and off, a spatial light modulator that modulates light from the light source, and a controller that alternately switches an image to be displayed between an image for the left eye and an image for the right eye and turns on the light source so that the image for the left eye or the image for the right eye is displayed. When the image for the left eye is displayed, the controller starts opens a shutter for the left eye in eyeglasses before turning on the light source, whereas when the image for the right eye is displayed, the controller starts opening a shutter for the right eye in the eyeglasses before turning on the light source.

### BACKGROUND

1. Technical Field

The present invention relates to an image display apparatus, an image display system, and an image display method.

2. Related Art

JP-A-2009-152897 discloses a stereoscopic video image display apparatus that displays stereoscopic video images by using a liquid crystal display. The stereoscopic video image display apparatus disclosed in JP-A-2009-152897 includes a liquid crystal display that alternatively displays video images for the left eye and video images for the right eye on a frame period basis in a time division manner, shutter eyeglasses including liquid crystal shutters L and R that block and unblock the left and right eyes, and a liquid crystal shutter controller that controls the blocking and unblocking operation of the liquid crystal shutters L and R.

The stereoscopic video display apparatus disclosed in JP-A-2009-152897, however, opens the liquid crystal shutters in each frame period (cycle) excluding periods in which image overlapping is noticeable (overlapping period) in order to display an image for the left or right eye that is not mixed with an image for the other eye, resulting in a problem of insufficient brightness of the displayed stereoscopic images.

### SUMMARY

An advantage of some aspects of the invention is to provide an image display apparatus, an image display system, and an image display method capable of displaying bright stereoscopic images.

An aspect of the invention is directed to an image display apparatus including a light source controlled to be turned on and off, a spatial light modulator that modulates light from the light source, a first controller that alternately switches an image to be displayed between an image for the left eye and an image for the right eye and turns on the light source so that the image for the left eye or the image for the right eye is displayed, and a second controller that starts opening a shutter for the left eye in eyeglasses before turning on the light source when the image for the left eye is displayed, whereas starting opening a shutter for the right eye in the eyeglasses before turning on the light source when the image for the right eye is displayed.

The image display apparatus, which starts opening the shutters in the eyeglasses before turning on the light source, can display bright stereoscopic images. Further, the image display apparatus allows power consumption per field period to be reduced by the amount corresponding to the period during which the light source is turned off. Moreover, the image display apparatus can display brighter stereoscopic images by increasing the level of current for driving the light source to emit light.

In the image display apparatus according to the aspect of the invention, the second controller may start opening the shutters before the timing at which the light source is turned on by a period necessary for the shutters to be fully opened.

The image display apparatus can therefore display bright stereoscopic images in accordance with the temporal response of the shutters.

In the image display apparatus according to the aspect of the invention, the second controller may close the shutters in synchronization with the timing at which the light source is turned off.

The image display apparatus can therefore display bright stereoscopic images in accordance with the temporal response of the shutters.

In the image display apparatus described above, the first controller may turn off the light source in synchronization with the timing at which the image to be displayed is switched between the image for the left eye and the image for the right eye.

The image display apparatus can therefore display only video images for the left or right eye that are not mixed with video images for the other eye and hence reduce the amount of crosstalk.

In the image display apparatus according to the aspect of the invention, the light source may emit color light fluxes at respective intensities according to drive current levels determined for the respective colors.

The image display apparatus can therefore adjust the intensity of emitted light for each of the colors, whereby color adjustment can be readily performed and stereoscopic images can be displayed with white balance adjusted.

In the image display apparatus described above, the first controller may adjust the intensity of light emitted from the light source in such a way that among the colors of the light passing through the eyeglasses, the intensity of emitted light of a low transmitting color is greater than the intensities of emitted light of the other colors.

The image display apparatus can therefore display stereoscopic images with white balance adjusted.

In the image display apparatus according to the aspect of the invention, the first controller may adjust the intensity of light emitted from the light source by changing a duty ratio of a PWM signal.

The image display apparatus can therefore readily adjust the brightness with no low-frequency flickering.

In the image display apparatus described above, the first controller may set the frequency of the PWM signal to be an integral multiple of the frequency of each field.

The image display apparatus can therefore display bright stereoscopic images having adjusted brightness without low-frequency flickering.

Another aspect of the invention is directed to an image display system including any of the image display apparatus described above and eyeglasses that alternately transmit an image for the left eye and an image for the right eye displayed by the image display apparatus in synchronization with a timing notified by the image display apparatus.

The image display system, which starts opening the shutters in the eyeglasses before turning on the light source, can display bright stereoscopic images. Further, the image display system allows power consumption per field period to be reduced by the amount corresponding to the period during which the light source is turned off. Moreover, the image display system can display brighter stereoscopic images by increasing the level of current for driving the light source to emit light.

Still another aspect of the invention is directed to an image display method in an image display apparatus, the method including controlling a light source to be turned on and off, allowing a spatial light modulator to modulate light from the light source, allowing a first controller to alternately switch an image to be displayed between an image for the left eye and an image for the right eye and turn on the light source so that the image for the left eye or the image for the right eye is displayed, and allowing a second controller to start opening a shutter for the left eye in eyeglasses before turning on the light source when the image for the left eye is displayed, whereas starting opening a shutter for the right eye in the eyeglasses before turning on the light source when the image for the right eye is displayed.

The image display method in an image display apparatus, which includes starting opening the shutters in the eyeglasses before turning on the light source, allows bright stereoscopic images to be displayed. Further, the image display method in an image display apparatus allows power consumption per field period to be reduced by the amount corresponding to the period during which the light source is turned off. Moreover, the image display method in an image display apparatus allows brighter stereoscopic images to be displayed by increasing the level of current for driving the light source to emit light.

According to the aspects of the invention, the image display apparatus, which starts opening the shutters in the eyeglasses before turning on the light source, can display bright stereoscopic images.

### BRIEF DESCRIPTION OF THE DRAWINGS

The invention will be described with reference to the accompanying drawings, wherein like numbers reference like elements.

FIG. 1 is a block diagram showing an example of the configuration an image display apparatus in a first embodiment of the invention.

FIG. 2 is a block diagram showing an example of a circuit configuration of the image display apparatus in the first embodiment of the invention.

FIG. 3 is a time chart showing the relationship between a PWM signal and the temporal response of a shutter in each eyeglass in the first embodiment of the invention.

FIG. 4 is a time chart showing the relationship between the PWM signal and the temporal response of the shutter in each eyeglass in a second embodiment of the invention.

FIG. 5 shows PWM signals in cases where the frequency of each of the PWM signals is an integral multiple of the frequency of each field in the second embodiment of the invention.

FIG. 6 shows PWM signals in cases where the frequency of neither of the PWM signals is an integral multiple of the frequency of each field in the second embodiment of the invention.

FIG. 7 is a time chart showing the relationship between the PWM signal and the temporal response of the shutter in each eyeglass in a third embodiment of the invention.

### DESCRIPTION OF EXEMPLARY EMBODIMENTS

### First Embodiment

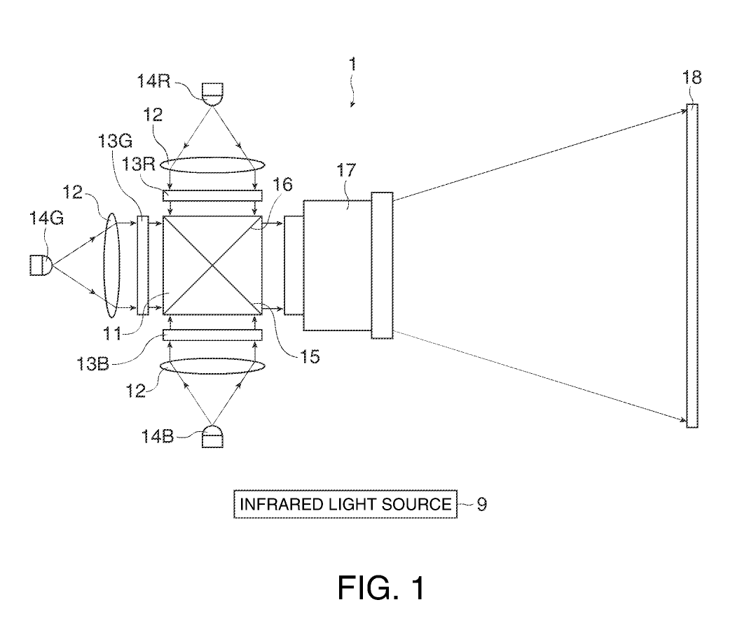

A first embodiment of the invention will be described in detail with reference to the drawings. FIG. 1 is a block diagram showing an example of the configuration an image display apparatus. An image display system includes an image display apparatus (projector) 1 and eyeglasses (not shown) that alternately transmit images for the left eye and images for the right eye displayed by the image display apparatus 1 in synchronization with timings notified by the image display apparatus 1.

The image display apparatus 1 includes an optical system and an infrared light source (infrared LED) 9. The optical system includes an LED 14R for red light (R light), an LED 14G for green light (G light), an LED 14B for blue light (B light), collimator lenses 12, a spatial light modulator 13R for red light, a spatial light 13G modulator for green light, a spatial light modulator 13B for blue light, a cross dichroic prism 11, and a projection lens 17.

The red light LED (red light source) 14R is a solid-state light source and emits red light LR. The red light emitted from the red light LED 14R is parallelized by the corresponding collimator lens 12 and incident on the spatial light modulator 13R. The spatial light modulator 13R for red light is a transmissive liquid crystal light valve that scans a plurality of pixels to modulate the red light based on transmittance controlled on a pixel basis in accordance with an image signal. The red light modulated by the spatial light modulator 13R for red light is incident on the cross dichroic prism 11.

The green light LED (green light source) 14G is a solid-state light source and emits green light LG. The green light emitted from the green light LED 14G is parallelized by the corresponding collimator lens 12 and incident on the spatial light modulator 13G. The spatial light modulator 13G for green light is a transmissive liquid crystal light valve that scans a plurality of pixels to modulate the green light based on transmittance controlled on a pixel basis in accordance with an image signal. The green light modulated by the spatial light modulator 13G for green light is incident on the cross dichroic prism 11 from a direction different from the direction in which the red light is incident on the cross dichroic prism 11.

The blue light LED (blue light source) 14B is a solid-state light source and emits blue light LB. The blue light emitted from the blue light LED 14B is parallelized by the corresponding collimator lens 12 and incident on the spatial light modulator 13B. The spatial light modulator 13B for blue light is a transmissive liquid crystal light valve that scans a plurality of pixels to modulate the blue light based on transmittance controlled on a pixel basis in accordance with an image signal. The blue light modulated by the spatial light modulator 13B for blue light is incident on the cross dichroic prism 11 from a direction different from the directions in which the red light and the green light are incident on the cross dichroic prism 11. In the following description, the red light LED 14R, the green light LED 14G, and the blue light LED 14B are collectively called “light sources 14.”

The image display apparatus 1 may further includes a homogenizing system for homogenizing the intensity distribution of a light flux, for example, a rod integrator or a fly's eye lens.

The cross dichroic prism 11 is an optical system that combines the red light, the green light, and the blue light. The cross dichroic prism 11 includes a first dichroic filter 15 and a second dichroic filter 16. The first dichroic filter 15 and the second dichroic filter 16 are disposed to be substantially perpendicular to each other.

The first dichroic filter 15 reflects the red light and transmits the green light and the blue light. On the other hand, the second dichroic filter 16 reflects the blue light and transmits the red light and the green light. The red light, the green light, and the blue light are thus combined and incident on the projection lens 17. The projection lens 17 projects the combined light from the cross dichroic prism 11 on a screen 18. An image according to the image signals is thus projected on the screen 18.

In the following sections, the eyeglasses are divided into two, one for the left eye and the other for the right eye, that is, an eyeglass for the left eye and an eyeglass for the right eye, for ease of description. The eyeglasses may be integrated eyeglasses formed of the eyeglass for the left eye and the eyeglass for the right eye as described in the present embodiment. The infrared light source 9 receives pulse signals from an infrared light source driver 8. The infrared light source 9 delivers infrared light according to the pulse signals to the eyeglass for the left eye and the eyeglass for the right eye (not shown).

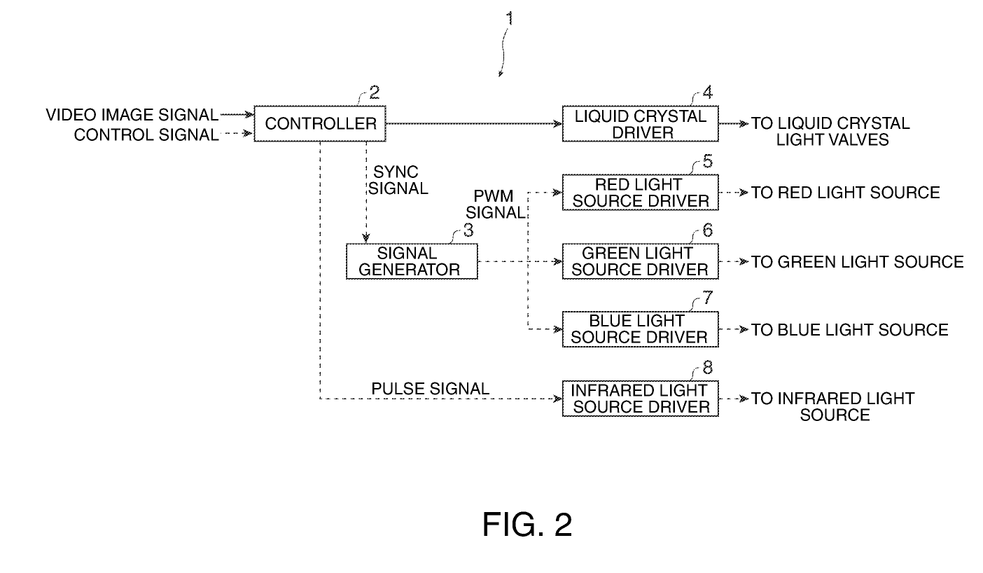

FIG. 2 is a block diagram showing an example of a circuit configuration of the image display apparatus. The image display apparatus 1 further includes a controller 2, a signal generator 3, a liquid crystal driver 4, a red light source driver 5, a green light source driver 6, a blue light source driver 7, and the infrared light source driver 8.

The controller 2 controls the timing at which the light sources 14 (see FIG. 1) are turned on to start emitting light in such a way that images for the left eye and images for the right eye are alternately displayed on the screen 18 (see FIG. 1). The controller 2 receives a video image signal and a control signal. The video image signal carries images L for the left eye and images R for the right eye captured by using binocular parallax. The controller 2 performs image processing (decoding, for example) on the video image signal based on the control signal and outputs the video image signal having undergone the image processing to the liquid crystal driver 4.

The controller 2 further outputs a vertical sync signal (VSYNC) to the signal generator 3. The controller 2 further notifies the signal generator 3 of white balance.

The controller 2 opens a liquid crystal shutter in the eyeglass for the left eye (left side of eyeglasses) (not shown), which transmits the light carrying the images L for the left eye, before the light sources 14 start emitting light. The controller 2 further opens a liquid crystal shutter in the eyeglass for the right eye (right side of eyeglasses) (not shown), which transmits the light carrying the images R for the right eye, before the light sources 14 start emitting light. The controller 2 then starts closing the liquid crystal shutters in the eyeglasses on an eyeglass basis in synchronization with the timing at which the light sources 14 are turned off. When the liquid crystal shutters are closed, image light is blocked.

The controller 2 outputs pulse signals representing the timings at which the left and right liquid crystal shutters are alternately opened or closed to the infrared light source driver 8 on an eyeglass basis in order to alternately transmit the light carrying the images L for the left eye and the light carrying the images R for the right eye. To alternatively open or close the left and right liquid crystal shutters, the phase of the pulse signal for the eyeglass for the left eye and the phase of the pulse signal for the eyeglass for the right eye differ from each other by a period during which a single field image, which is switched to another in synchronization with the vertical sync signal, keeps being displayed (hereinafter referred to as “field period”) (about 8.33 [msec]).

The liquid crystal driver 4 outputs driver signals for liquid crystal driving (scanning) to the spatial light modulators 13R, 13G, and 13B (see FIG. 1), each of which is a liquid crystal light valve. The liquid crystal driving is performed twice per field period (at a frequency of 240 [Hz]) from the upper end to the lower end of an image plane of each of the spatial light modulators.

The signal generator 3 generates a PWM (pulse width modulation) signal under the control of the controller 2 in synchronization with the vertical sync signal. When the PWM signal is ON (has high level), the light sources 14 emit light, whereas when the PWM signal is OFF (has low level), the light sources 14 emit no light.

The signal generator 3 outputs information on the level of current (hereinafter referred to as “current level information”) to the red light source driver 5, the green light source driver 6, and the blue light source driver 7. The current level information is so determined based on the white balance notified by the controller 2 that among the colors that form image light passing through the liquid crystal shutters, the intensity of emitted light of a low transmitting color (blue light LB, for example, which has shorter wavelength) is greater than those of the other colors.

The red light source driver 5, when the PWM signal is ON, drives the red light LED 14R (see FIG. 1), which is the red light source, to emit red light LR at the emitted light intensity according to the current level represented by the current level information. The red light source driver 5 turns off the red light source when the PWM signal becomes OFF.

The green light source driver 6, when the PWM signal is ON, drives the green light LED 14G (see FIG. 1), which is the green light source, to emit green light LG at the emitted light intensity according to the current level represented by the current level information. The green light source driver 6 turns off the green light source when the PWM signal becomes OFF.

The blue light source driver 7, when the PWM signal is ON, drives the blue light LED 14B (see FIG. 1), which is the blue light source, to emit blue light LB at the emitted light intensity according to the current level represented by the current level information. The blue light source driver 7 turns off the blue light source when the PWM signal becomes OFF.

It is noted that since the light sources 14 (see FIG. 1) are cooled during a period in which the light sources 14 do not emit light, each of the light source drivers may drive the corresponding light source by using a greater current level than a case where the light source keeps emitting light throughout a field period. For example, since the current level I_{2D} required to keep each of the light sources 14 emitting light throughout a single field period and the current level I_{3D} required to cause the light source 14 to emit light in only part of a single field period substantially satisfy I_{3D}=I_{2D}/(duty ratio of PWM signal), the current level I_{3D} can be increased to the extent that it does not exceed the value of the right side of the expression. Further, since each of the light sources 14 does not keep emitting light throughout a single field period, the lifetime of the light source 14 can be prolonged.

The infrared light source driver 8 outputs the pulse signals inputted from the controller 2 to the infrared light source 9. The infrared light source 9 then delivers infrared light according to each of the pulse signals to the corresponding eyeglass (not shown). The liquid crystal shutter in the eyeglass that receives the infrared light according to the pulse signal does not respond immediately but makes a transient change.

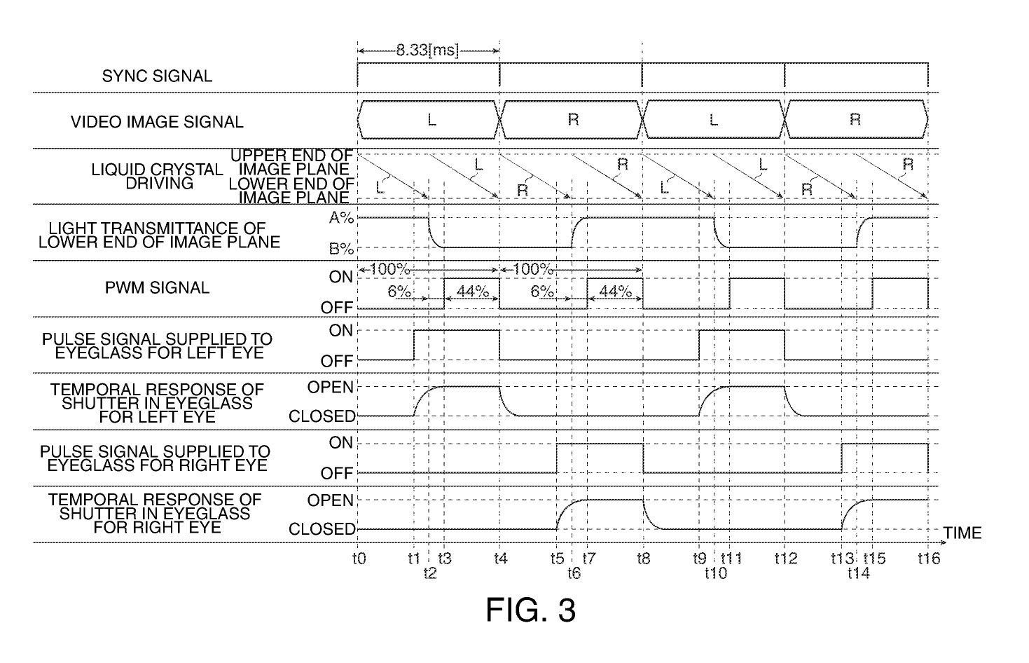

FIG. 3 is a time chart showing the relationship between the PWM signal and the temporal response of the shutter in each of the eyeglasses. The sync signal in FIG. 3 is the vertical sync signal representing the boundary between field periods. In FIG. 3, time t0, t4, t8, and t12 corresponds to the boundary between field periods.

The video image signal in FIG. 3 carries images L for the left eye and images R for the right eye. An image L for the left eye is displayed in the field period from time t0 to t4 and the field period from time t8 to t12, and an image R for the right eye is displayed in the field period from time t4 to t8 and the field period from time t12 to t16.

The liquid crystal driving in FIG. 3 represents line sequential scanning in each of the spatial light modulators 13R, 13G, and 13B (see FIG. 1). The liquid crystal driving for displaying an image L for the left eye ends at the time t2, t4, t10, and t12. Similarly, the liquid crystal driving for displaying an image R for the right eye ends at the time t6, t8, t14, and t16.

The light transmittance of a lower end of an image plane in FIG. 3 represents light transmittance of the portion of each of the spatial light modulators 13R, 13G, and 13B (see FIG. 1) in the vicinity of the last pixel having undergone the liquid crystal driving. Let B[%] be light transmittance (target value) for displaying an image L for the left eye. Similarly, let A[%] (>B[%]) be light transmittance (target value) for displaying an image R for the right eye.

The PWM signal in FIG. 3 represents the PWM signal generated by the signal generator 3. It is assumed in the first embodiment that the duty ratio of the PWM signal is, for example, determined in advance to be 44% with each field period being 100%. The duty ratio is so determined in advance that the light sources 14 emit light only in a period during which the light transmittance of the lower end of the image plane of each of the spatial light modulators reaches a target value and remains there. That is, the duty ratio is so determined in advance that the transmittance has reached the target value when the light sources 14 start emitting light. Further, the PWM signal is so determined in advance that the period during which the PWM signal is ON is within a single field period.

It is, for example, assumed that when the liquid crystal driving L ends at the time t2, the light transmittance of the lower end of the image plane of each of the spatial light modulators becomes B [%] at the time t3. The temporal response of the liquid crystal material is assumed to have been measured in advance as a characteristic thereof. In this case, the PWM signal is set to be ON (have high level) at the time t3. Further, the PWM signal is set to be OFF (have low level) at the time t4 when the field period in question ends.

The pulse signal supplied to the eyeglass for the left eye in FIG. 3 is a pulse signal delivered in the form of infrared light from the infrared light source driver 8 (see FIG. 2) through the infrared light source 9 to the eyeglass for the left eye. The temporal response of the shutter in the eyeglass for the left eye in FIG. 3 is the temporal response of the liquid crystal shutter that is opened or closed in response to the pulse signal.

The pulse signal supplied to the eyeglass for the left eye becomes ON before the timing at which the light sources 14 are turned on by a period necessary for the liquid crystal shutter to be fully opened (time t1 and t9). After the pulse signal becomes ON, the liquid crystal shutter makes a transient change and is eventually fully opened (time t3 and t11). The pulse signal becomes OFF in synchronization with the timing at which the light sources 14 are turned off (time t4 and t12). After the pulse signal becomes OFF, the liquid crystal shutter in the eyeglass for the left eye makes a transient change and is eventually fully closed.

The pulse signal supplied to the eyeglass for the right eye in FIG. 3 is a pulse signal delivered in the form of infrared light from the infrared light source driver 8 through the infrared light source 9 to the eyeglass for the right eye. The pulse signal supplied to the eyeglass for the right eye changes in the same manner as the pulse signal supplied to the eyeglass for the left eye but with a delay of a single field with respect thereto. The temporal response of the shutter in the eyeglass for the right eye in FIG. 3 is the temporal response of the liquid crystal shutter that is opened or closed in response to the pulse signal.

The pulse signal supplied to the eyeglass for the right eye becomes ON before the timing at which the light sources 14 are turned on by a period necessary for the liquid crystal shutter is fully opened (time t5 and t13). After the pulse signal becomes ON, the liquid crystal shutter makes a transient change and is eventually fully opened (time t7 and t15). The pulse signal becomes OFF in synchronization with the timing at which the light sources 14 are turned off (time t8 and t16). After the pulse signal becomes OFF, the liquid crystal shutter in the eyeglass for the right eye makes a transient change and is eventually fully closed. The image display apparatus 1 repeats the same operation in the following field periods.

As described above, the period during which the pulse signal is ON is set to be longer than the period during which the PWM signal is ON. In each field period, either of the liquid crystal shutters is fully opened before the light sources 14 start emitting light and the liquid crystal shutter is closed when the field period ends, whereby the image display apparatus can display bright stereoscopic images with the light transmittance of the corresponding eyeglass maximized.

As described above, the image display apparatus 1 includes the light sources controlled to be turned on and off; the spatial light modulators 13R, 13G, and 13B, which modulate the light from the respective light sources; the controller 2, which alternately switches the image to be displayed between images for the left eye and images for the right eye and turns on the light sources so that images for the left eye or images for the right eye are displayed. When an image for the left eye is displayed, the controller 2 starts opening the shutter in the eyeglass for the left eye before turning on the light sources, whereas when an the image for the right eye is displayed, the controller 2 starts opening the shutter in the eyeglass for the right eye before turning on the light sources.

The thus configured image display apparatus, which starts opening the shutters in the eyeglasses before turning on the light sources, can display bright stereoscopic images. Further, the image display apparatus allows the power consumption per field period to be reduced by the amount corresponding to the period during which the light sources are turned off. Moreover, the image display apparatus can display brighter stereoscopic images by increasing the level of current for driving the light sources to emit light.

### Second Embodiment

A second embodiment of the invention will be described in detail with reference to the drawings. The second embodiment differs from the first embodiment in that the level of current for driving the light sources is changed by changing the duty ratio of the PWM signal so that the intensity of the light emitted from the light sources is adjusted (light control). Only the difference between the first and second embodiments will be described below.

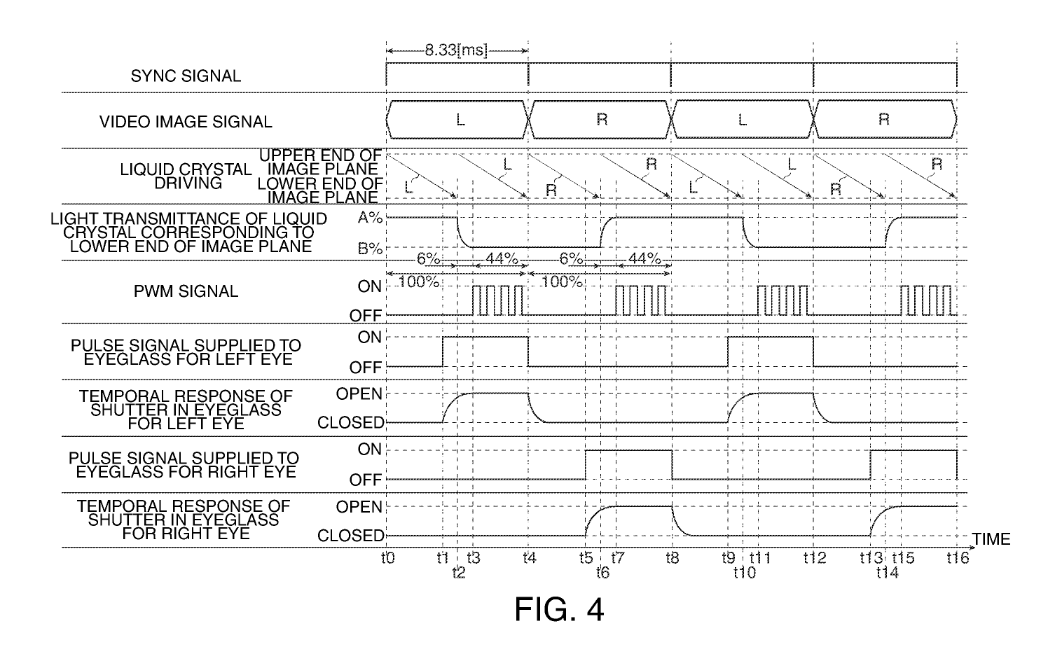

The image display apparatus 1 further includes a storage section (not shown). The storage section stores a lookup table (hereinafter referred to as “LUT”) representing the relationship between the duty ratio of the PWM signal and the intensity of emitted light. The controller 2 (see FIG. 2) refers to the LUT. The duty ratio of the PWM signal in the second embodiment will be described with reference to FIGS. 4 to 6.

FIG. 4 is a time chart showing the relationship between the PWM signal and the temporal response of the shutter in each of the eyeglasses. FIG. 4 differs from FIG. 3 only in terms of the waveform of the PWM signal, and only the PWM signal in the second embodiment will therefore be described.

The controller 2 controls the signal generator 3 (see FIG. 2) in such a way that the frequency of the PWM signal is an integral multiple of the frequency of each field (120 [Hz]). FIG. 4 shows a case where the frequency of the PWM signal is nine times the frequency of each field (=1080 [Hz]). The reason for this is to prevent low-frequency flickering from occurring.

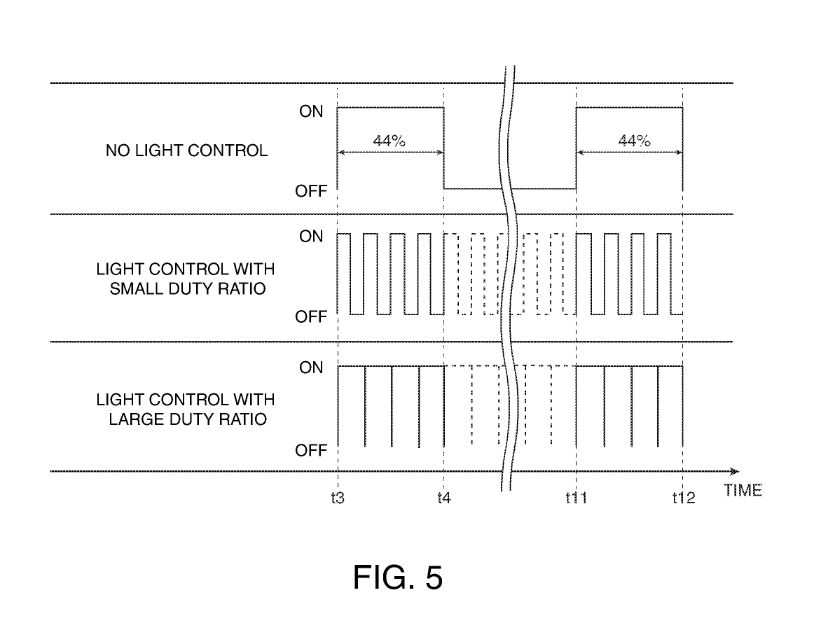

Low-frequency flickering will be described below. FIG. 5 shows PWM signals in cases where the frequency of each of the PWM signals is an integral multiple of the frequency of each field. The upper portion of FIG. 5 shows a PWM signal in a case where no light control is performed for comparison purposes. The middle portion of FIG. 5 shows a PWM signal in a case where light control is performed and the duty ratio of the PWM signal is relatively small in FIG. 5. The lower portion of FIG. 5 shows a PWM signal in a case where light control is performed and the duty ratio of the PWM signal is relatively large in FIG. 5.

The controller 2 performs light control by referring to the LUT stored in the storage section (not shown) to change the duty ratio in such a way that a target intensity of emitted light is achieved.

Since the frequency of each of the PWM signals is an integral multiple of the frequency of each field as shown in FIG. 5, the period during which the light sources emit light or emit no light agrees with the period during which the PWM signal is ON or OFF, whereby the area of the waveform of the PWM signal in the period from the time t3 to t4 is equal to the area of the waveform of the PWM signal in the period from the time 11 to t12. In this case, since the amount of light emission in the period from the time t3 to t4 is equal to the amount of light emission in the period from the time t11 to t12, the brightness of images is stable and no low-frequency flickering will occur.

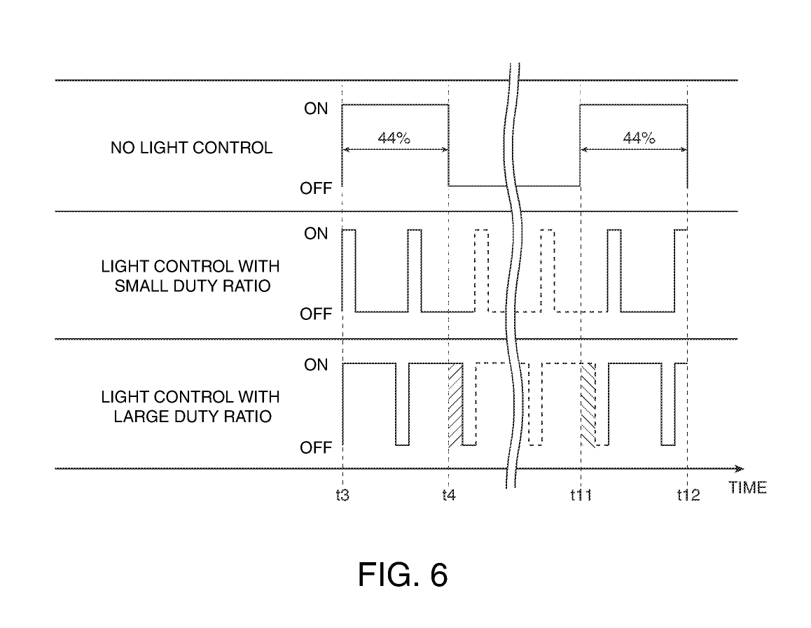

On the other hand, FIG. 6 shows PWM signals in cases where the frequency of neither of the PWM signals is an integral multiple of the frequency of each field. The upper portion of FIG. 6 shows a PWM signal in a case where no light control is performed for comparison purposes. The middle portion of FIG. 6 shows a PWM signal in a case where light control is performed and the duty ratio of the PWM signal is relatively small in FIG. 6. The lower portion of FIG. 6 shows a PWM signal in a case where light control is performed and the duty ratio of the PWM signal is relatively large in FIG. 6.

Since the period during which the light sources emit light or emit no light does not agree with the period during which the PWM signal is ON or OFF particularly when the duty ratio of the PWM signal is relatively large as shown in the lower portion of FIG. 6, the area of the waveform of the PWM signal in the period from the time t3 to t4 is not equal to the area of the waveform of the PWM signal in the period from the time t11 to t12. In this case, since the amount of light emission in the period from the time t3 to t4 is not equal to the amount of light emission in the period from the time t11 to t12, the brightness of images is not stable and low-frequency flickering will occur.

The hatched portions shown in the lower portion of FIG. 6 are portions of the waveform of the PWM signal where the period during which the light sources emit light or emit no light does not agree with the period during which the PWM signal is ON or OFF. In this case, the duty ratio of the PWM signal is not proportional to the amount of light emission or they are in a nonlinear relationship. In view of the fact described above, the image display apparatus 1 can prevent low-frequency flickering from occurring by setting the frequency of the PWM signal to be an integral multiple of the frequency of each field, as shown in FIG. 5.

As described above, the controller 2 adjusts the amount of light emitted from the light sources 14 by changing the duty ratio of the PWM signal to change the average current level in a field period.

Further, the controller 2 sets the frequency of the PWM signal to be an integral multiple of the frequency of each field.

The image display apparatus 1 can therefore display bright stereoscopic images having adjusted brightness without low-frequency flickering.

### Third Embodiment

A third embodiment of the invention will be described in detail with reference to the drawings. The third embodiment differs from the first and second embodiments in that the liquid crystal driving method is a field writing method. Only the difference between the first/second embodiments and the third embodiment will be described below.

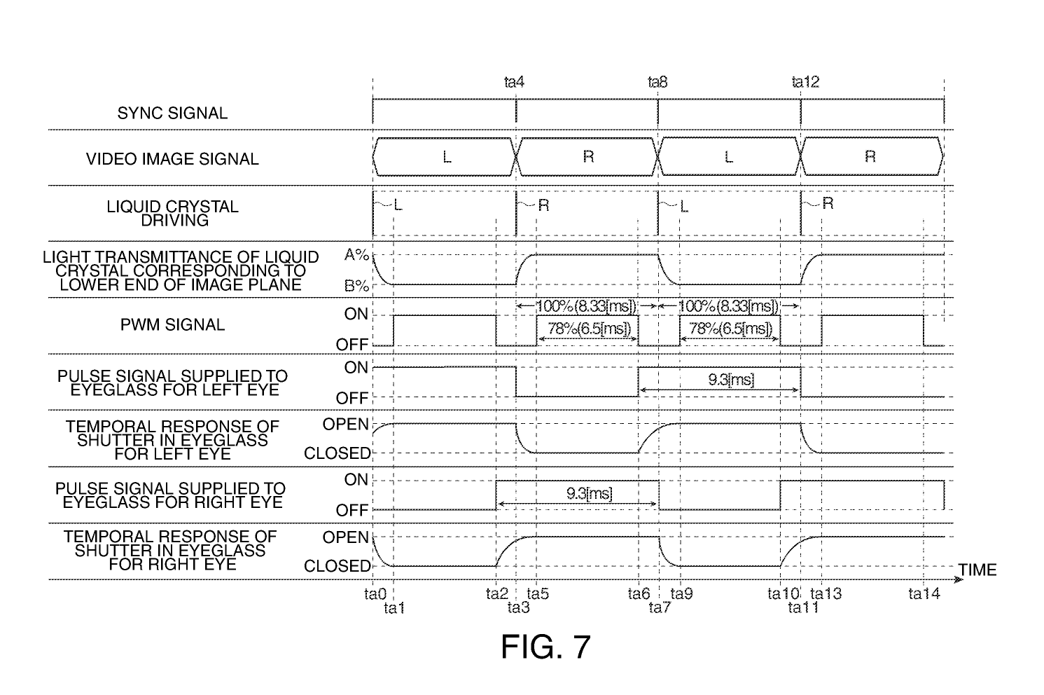

FIG. 7 is a time chart showing the relationship between the PWM signal and the temporal response of the shutter in each of the eyeglasses. The liquid crystal driving method in FIG. 7 is a field writing method. That is, the liquid crystal driving for displaying an image L for the left eye starts at time ta0, ta7, and ta14 and ends at substantially the same time as the starting time. Similarly, the liquid crystal driving for displaying an image R for the right eye starts at time ta3 and ta11 and ends at substantially the same time as the starting time.

The duty ratio of the PWM signal is determined in advance, for example, to be 78%. The duty ratio is so determined in advance that the light sources 14 emit light only in a period during which the light transmittance of the lower end of the image plane of each of the spatial light modulators reaches a target value and remains there. That is, the duty ratio is so determined in advance that the transmittance has been maximized when the light sources 14 start emitting light. Further, the PWM signal is so determined in advance that the period during which the PWM signal is ON is within a single field period.

It is, for example, assumed that when the liquid crystal driving L ends at the time ta0, the light transmittance of the lower end of the image plane of each of the spatial light modulators becomes B [%] at the time ta1. The temporal response of the liquid crystal material is assumed to have been measured in advance as a characteristic thereof. In this case, the PWM signal is set to be ON at the time ta1. The liquid crystal shutter in the eyeglass for the left eye is open at the time ta1. On the other hand, the liquid crystal shutter in the eyeglass for the right eye is closed at the time ta1.

In the following field period, the PWM signal becomes OFF before the timing at which the light sources 14 start emitting light (time ta5) by a period necessary for the liquid crystal shutter in the eyeglass for the right eye to be fully opened (time ta2). On the other hand, the pulse signal supplied to the eyeglass for the right eye becomes ON before the timing at which the light sources 14 start emitting light (time ta5) by a period necessary for the liquid crystal shutter to be fully opened (time ta2). The pulse signal supplied to the eyeglass for the left eye becomes OFF at the time ta3, which corresponds to the boundary between field periods. In FIG. 7, the period during which each of the pulse signals has the high level is 9.3 [msec]. The image display apparatus 1 repeats the same operation in the following field periods.

As described above, the image display apparatus 1 includes the light sources controlled to be turned on and off; the spatial light modulators 13R, 13G, and 13B, which modulate the light from the respective light sources; the controller 2, which alternately switches the image to be displayed between images for the left eye and images for the right eye and turns on the light sources so that images for the left eye or images for the right eye are displayed. When an image for the left eye is displayed, the controller 2 starts opening the shutter in the eyeglass for the left eye before turning on the light sources, whereas when an image for the right eye is displayed, the controller 2 starts opening the shutter in the eyeglass for the right eye before turning on the light sources.

When the liquid crystal driving method is a field writing method, the image display apparatus can display bright stereoscopic images while reducing an unnecessary period necessary to open or close the liquid crystal shutters by allowing the period during which the liquid crystal shutter for the left eyeglass is opened to overlap with the period during which the liquid crystal shutter for the right eyeglass is closed and vice versa.

Embodiments of the invention have been described in detail with reference to the drawings, but specific configurations are not limited to those shown in the embodiments, and similar designs that do not depart from the substance of the invention also fall within the scope of the invention.

For example, in the embodiments described above, in which each of the shutters is a liquid crystal shutter, the liquid crystal shutter may be replaced with any shutter that can be controlled to block and unblock light, for example, a mechanical shutter.

For example, in the embodiments described above, in which each of the spatial light modulators is a transmissive liquid crystal light valve, a reflective liquid crystal light valve, a digital micro-mirror device, and any other suitable device can be used.

Further, for example, the method for driving each of the spatial light modulators is not limited to the line sequential method or the field written method but may, for example, be a digitally scanning method.

Moreover, for example, the controller 2 may initialize the eyeglasses by keeping outputting high-level pulse signals for a fixed period.

Further, for example, the image display apparatus 1 may further include an operation unit that receives an input through user's operation. The image display apparatus 1 may perform light control based not only on video image adaptation or environment adaptation but also a mode setting (low brightness mode) inputted through the operation unit.

Moreover, for example, the image display apparatus 1 may work as a liquid crystal display that displays images instead of displaying images on the screen 18.

A program for embodying the image display apparatus and the image display system described above may be recorded on a computer readable recording medium, and a computer system may read and execute the program. The “computer system” used herein is a computer system including an OS, a peripheral device, and other hardware. The “computer readable recording medium” used herein refers to a flexible disc, a magneto-optical disc, a ROM, a CD-ROM, and other portable media, and a hard disk drive and other devices built in the computer system. The “computer readable recording medium” also includes a device that holds a program for a fixed period, such as a volatile memory (RAM) in a server or client computer system used in a case where the program is delivered via the Internet or any other network or a telephone line or any other communication line. Moreover, the program described above may be transmitted from a computer system including a storage device that stores the program to another computer system via a transmission medium or a transmitted wave in the transmission medium. The “transmission medium” that transmits the program described above is a medium having a function of transmitting information, such as the Internet or any other network (communication network) and a telephone line or any other communication line. Further, the program described above may be a program for achieving part of the function described above. Moreover, the program described above may achieve the function described above by combining programs stored in a computer system or by using what is called a differential file (differential program).

The entire disclosure of Japanese Patent Application No. 2010-264145, filed Nov. 26, 2010 is expressly incorporated by reference herein.

What is claimed is:

1. An image display apparatus comprising:
a light source controlled to be turned on and off;
a spatial light modulator that modulates light from the light source;
a first controller that alternately switches an image to be displayed between an image for the left eye and an image for the right eye and turns on the light source so that the image for the left eye or the image for the right eye is displayed; and
a second controller that starts opening a shutter for the left eye in eyeglasses before turning on the light source when the image for the left eye is displayed, whereas starting opening a shutter for the right eye in the eyeglasses before turning on the light source when the image for the right eye is displayed.

2. The image display apparatus according to claim 1,
wherein the second controller starts opening the shutters before the timing at which the light source is turned on by a period necessary for the shutters to be fully opened.

3. The image display apparatus according to claim 1,
wherein the second controller closes the shutters in synchronization with the timing at which the light source is turned off.

4. The image display apparatus according to claim 3,
wherein the first controller turns off the light source in synchronization with the timing at which the image to be displayed is switched between the image for the left eye and the image for the right eye.

5. The image display apparatus according to claim 1,
wherein the light source emits color light fluxes at respective intensities according to drive current levels determined for the respective colors.

6. The image display apparatus according to claim 5,
wherein the first controller adjusts the intensity of light emitted from the light source in such a way that among the colors of the light passing through the eyeglasses, the intensity of emitted light of a low transmitting color is greater than the intensities of emitted light of the other colors.

7. The image display apparatus according to claim 1,
wherein the first controller adjusts the intensity of light emitted from the light source by changing a duty ratio of a PWM signal.

8. The image display apparatus according to claim 7,
wherein the first controller sets the frequency of the PWM signal to be an integral multiple of the frequency of each field.

9. An image display system comprising:
the image display apparatus according to claim 1; and
eyeglasses that alternately transmit an image for the left eye and an image for the right eye displayed by the image display apparatus in synchronization with a timing notified by the image display apparatus.

10. An image display system comprising:
the image display apparatus according to claim 2; and
eyeglasses that alternately transmit an image for the left eye and an image for the right eye displayed by the image display apparatus in synchronization with a timing notified by the image display apparatus.

11. An image display system comprising:
the image display apparatus according to claim 3; and
eyeglasses that alternately transmit an image for the left eye and an image for the right eye displayed by the image display apparatus in synchronization with a timing notified by the image display apparatus.

12. An image display system comprising:
the image display apparatus according to claim 4; and
eyeglasses that alternately transmit an image for the left eye and an image for the right eye displayed by the image display apparatus in synchronization with a timing notified by the image display apparatus.

13. An image display system comprising:
the image display apparatus according to claim 5; and
eyeglasses that alternately transmit an image for the left eye and an image for the right eye displayed by the image display apparatus in synchronization with a timing notified by the image display apparatus.

14. An image display system comprising:
the image display apparatus according to claim 6; and
eyeglasses that alternately transmit an image for the left eye and an image for the right eye displayed by the image display apparatus in synchronization with a timing notified by the image display apparatus.

15. An image display system comprising:
the image display apparatus according to claim 7; and
eyeglasses that alternately transmit an image for the left eye and an image for the right eye displayed by the image display apparatus in synchronization with a timing notified by the image display apparatus.

16. An image display system comprising:
the image display apparatus according to claim 8; and
eyeglasses that alternately transmit an image for the left eye and an image for the right eye displayed by the image display apparatus in synchronization with a timing notified by the image display apparatus.

17. An image display method in an image display apparatus, the method comprising:
controlling a light source to be turned on and off;
allowing a spatial light modulator to modulate light from the light source;
allowing a first controller to alternately switch an image to be displayed between an image for the left eye and an image for the right eye and turn on the light source so that the image for the left eye or the image for the right eye is displayed; and
allowing a second controller to start opening a shutter for the left eye in eyeglasses before turning on the light source when the image for the left eye is displayed, whereas starting opening a shutter for the right eye in the eyeglasses before turning on the light source when the image for the right eye is displayed.
